(19) United States
(12) Patent Application Publication
(10) Pub. No.: US 2014/0314075 A1
(43) Pub. Date: Oct. 23, 2014

(54) COMMUNICATION SYSTEM, APPLICATION DEVICE AND COMMUNICATION METHOD SUPPORTING CIRCUIT SWITCH AND PACKET SWITCH

(71) Applicant: Wistron NeWeb Corporation, Hsinchu (TW)

(72) Inventors: Zhe-Hua Chou, Hsinchu (TW); Yu-Jen Chen, Hsinchu (TW); Ying-Hui Liang, Hsinchu (TW)

(73) Assignee: Wistron NeWeb Corporation, Hsinchu (TW)

(21) Appl. No.: 13/949,419

(22) Filed: Jul. 24, 2013

(30) Foreign Application Priority Data
Apr. 23, 2013 (TW) 102114353

(51) Int. Cl. H04L 12/933

(52) U.S. Cl. CPC H04L 49/10
USPC 370/354

(57) ABSTRACT

The present invention discloses a communication system supporting Circuit Switch (CS) and Packet Switching (PS), which includes several CS communication devices, an application device and at least one network communication device. The network communication device builds a connection with a PS communication unit of the application device through a network. When the CS communication devices communicate with a CS communication unit of the application device through a CS interface, a processing unit of the application device converts several voice signals transmitted between the CS communication devices and the at least one network communication device, such that the CS communication devices builds a voice connection with the at least one network communication device. The present invention also discloses an application device and a communication method supporting CS and PS.

### RELATED APPLICATIONS

This application claims priority to Taiwanese Application Serial Number 102114353, filed Apr. 23, 2013, which is herein incorporated by reference.

### BACKGROUND

1. Technical Field

The present invention relates to a communication system, an application device and a communication method for crossing switching interfaces. More particularly, the present invention relates to a communication system, an application device and a communication method supporting circuit switching and packet switching.

2. Description of Related Art

Voice over Internet Protocol (VoIP) is a technology for voice communications and multimedia sessions through Internet Protocol (IP) networks. With the increase in the coverage of the Internet and the voice communication across countries, more and more long-distance calls are accomplished through the VoIP. From the advantages of low calling rate, low cost of infrastructure, good extendibility and improving voice quality, VoIP has become a fierce competitor for those conventional telecommunication companies.

The VoIP adopts Packet Switching (PS) in communication. Hence, The VoIP were usually applied in the intranet of large-size companies, and, therefore, the phone costs can be saved by providing both data and voice services through the same intranet. However, such calling service for muti-users can only be provided for the users under the same switching interface.

### SUMMARY

According to one embodiment of this invention, a communication system supporting Circuit Switch (CS) and Packet Switching (PS) is disclosed to utilize an application device to convert and transmit voice signals from different switching interfaces. The communication system supporting CS and PS includes several CS communication devices, an application device and at least one network communication device. The application device includes a CS communication unit, a PS communication unit and a processing unit. The processing unit is electrically connected to the CS communication unit and the PS communication unit. The network communication device builds a connection with a network. The network communication device builds a connection with the PS communication unit of the application device through the network. When the CS communication devices communicate with the CS communication unit of the application device through a CS interface, the processing unit of the application device converts several voice signals transmitted between the CS communication devices and the at least one network communication device, such that the CS communication devices builds a voice connection with the at least one network communication device.

According to another embodiment of this invention, an application device supporting CS and PS includes a CS communication unit, a PS communication unit and a processing unit. The processing unit is electrically connected to the CS communication unit and the PS communication unit. At least one network communication device builds a connection with the PS communication unit of the application device through a network. When several CS communication devices communicate with the CS communication unit of the application device through a CS interface, the processing unit of the application device converts a plurality of voice signals transmitted between the CS communication devices and the network communication device, such that the CS communication devices builds a voice connection with the at least one network communication device.

According to another embodiment of this invention, a communication method supporting CS and PS is disclosed. The communication method supporting CS and PS includes the following steps:

(a) at least one network communication device is utilized to build a connection with a PS communication unit of an application device through a network;

(b) several CS communication devices are utilized to communicate with a CS communication unit of the application device through a CS interface; and

(c) the application device is utilized to convert several voice signals transmitted between the CS communication devices and the at least one network communication device, such that the CS communication devices builds a voice connection with the at least one network communication device.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a block diagram of a communication system supporting Circuit Switch (CS) and Packet Switching (PS) according to one embodiment of this invention;

FIG. 2 is a block diagram of a communication system supporting CS and PS according to another embodiment of this invention; and

FIG. 3 is a flow diagram of a communication method supporting CS and PS according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

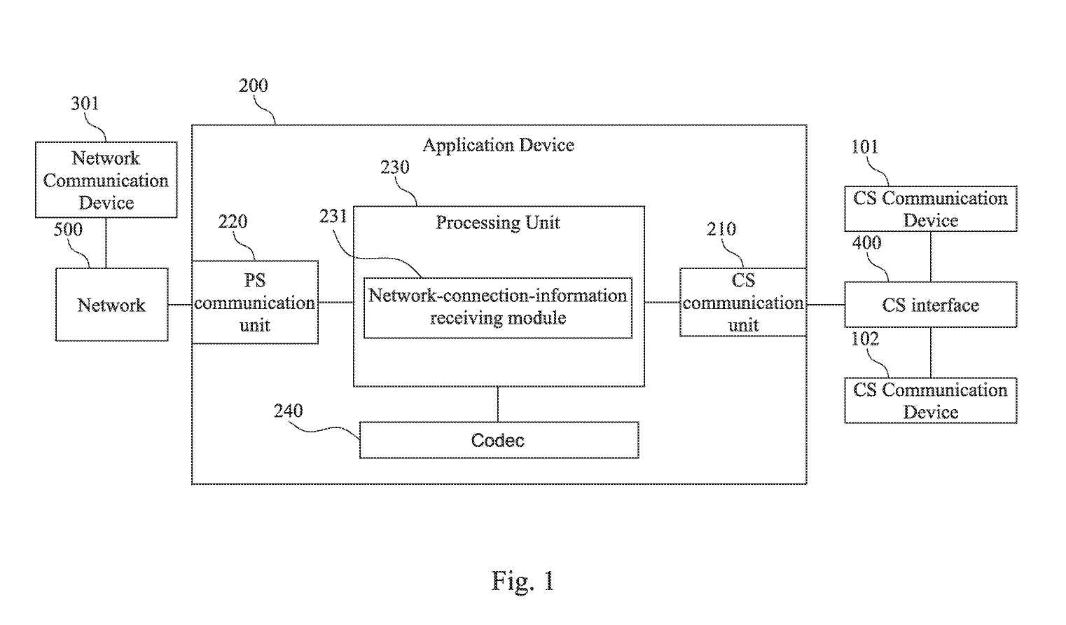

Referring to FIG. 1, a block diagram will be described that illustrates a communication system supporting Circuit Switch (CS) and Packet Switching (PS) according to one embodiment of this invention. The communication system supporting CS and PS utilizes an application device to convert and transmit voice signals from different switching interfaces.

The communication system supporting CS and PS includes several CS communication devices 101, 102, an application device 200 and at least one network communication device 301. The application device 200 includes a CS communication unit 210, a PS communication unit 220 and a processing unit 230. The processing unit 230 is electrically connected to the CS communication unit 210 and the PS communication unit 220.

The network communication device 301 builds a connection with a network 500. Wherein, the network communication device 301 may utilize a wired or wireless network communication protocol to build a connection with the network 500.

The network communication device 301 builds a connection with the PS communication unit 220 of the application device 200 through the network 500. In some embodiments of this invention, the PS communication unit 220 of the application device 200 may register information about an installed subscriber identity module (SIM) to a specific server on the network 500. The information about the installed SIM may be the telephone number of the SIM installed in the application device 200. The network communication device 301 may upload its network connection information through the network 500. The network connection information of the network communication device 301 may be an Internet Protocol (IP) address or any other information about the network communication device 301 building the connection with the network 500. A network-connection-information receiving module 231 of the processing unit 230 receives the network connection information about the network communication device 301 building the connection with the network 500. Then, a connection between the network communication device 301 and the application device 200 can be built according to the network connection information. Wherein, an application (APP) program can be implemented for building the connection between the network communication device 301 and the application device 200, and the network communication device 301 can install such APP program.

When there is a need for communicating across several switching interfaces, the CS communication devices 101, 102 communicate with the CS communication unit 210 of the application device 200 through a CS interface 400. Wherein, such communication can be accomplished through a Home Public Land Mobile Network (HPLMN). In addition, the communication can be initiated by one of the CS communication devices 101, 102 and the application device 200.

When the CS communication devices 101, 102 communicate with the CS communication unit 210 of the application device 200 through the CS interface 400, the processing unit 230 of the application device 200 converts several voice signals transmitted between the CS communication devices 101, 102 and the network communication device 301, such that the CS communication devices 101, 102 builds a voice connection with the network communication device 301. The voice signals to be converted may include at least one CS signals received from the CS communication devices 101, 102 and at least one PS packet received from the network communication device 301. In addition the application device 200 may further include a codec 240 electrically connected to the processing unit 230. The codec 240 converts the at least one CS signal received from the CS communication devices 101, 102 (such as the signal in an Adaptive Multi-Rate speech codec format) into at least one signal in a PS format (such as ITU-T G.711 speech codec format) for the processing unit 230 to transmit to the at least one network communication device 301. The codec 240 converts the at least one PS packet received from the network communication device 301 (such as the signal in ITU-T G.711 speech codec format) into at least one signal in a CS format (such as the signal in an Adaptive Multi-Rate speech codec format) for the processing unit 230 to transmit to the CS communication devices 101, 102. Therefore, the network communication device 301, which builds a connection through the network 500, can participate in a multi-user talk with the CS communication devices 101, 102.

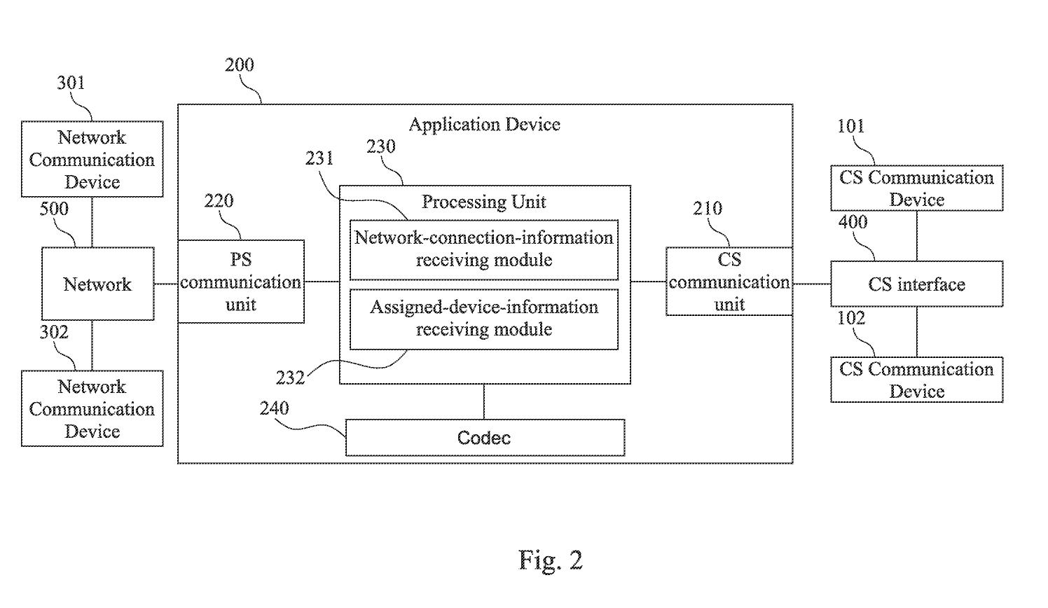

Referring to FIG. 2, a block diagram will be described that illustrates a communication system supporting CS and PS according to another embodiment of this invention. It is to be understood that aspects of this embodiment similar to those described with reference to FIG. 1 may not be repeated.

In this embodiment, the communication system supporting CS and PS includes several network communication devices 301, 302. The processing unit 230 further includes an assigned-device-information receiving module 232. Each of the network communication devices 301, 302 uploads its own network connection information to be registered to the application device 200. Hence, the network-connection-information receiving module 231 receives network connection information about each of the network communication devices 301, 302 building the connection with the network 500. Wherein, the application device 200 may transmit the network connection information of the network communication devices 301, 302 to at least one of the CS communication devices 101, 102. Hence, one of the CS communication devices 101, 102 can assign a target for communication and generate corresponding assigned device information. For example, one of the CS communication devices 101, 102 can call the application device, and then generates a button signal corresponding to the telephone number key “#2”, which can be taken as the assigned device information, such that the network communication device corresponding to the telephone number key “#2” may be assigned. In other embodiments of this invention, more network communication devices or all network communication devices may be assigned, which should not be limited in this disclosure. After the target for communication is assigned, the processing unit 230 drives the CS communication devices 101, 102 to build the voice connection with the assigned network communication device according to the network connection information. Therefore, the CS communication devices 101, 102 can held a multi-user talk with the assigned network communication device.

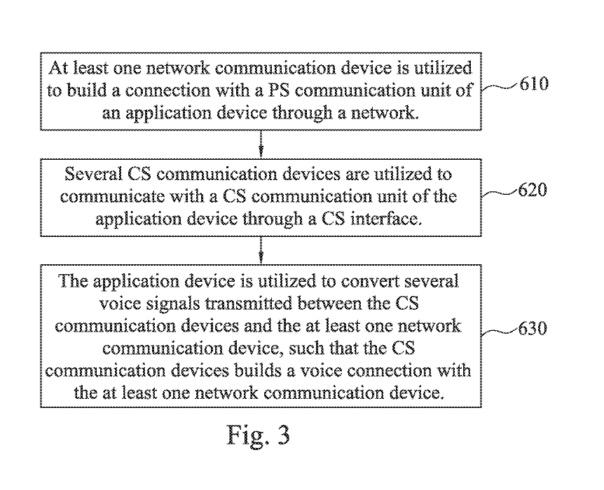

Referring to FIG. 3, a flow diagram will be described that illustrates a communication method supporting CS and PS according to one embodiment of this invention. The communication method supporting CS and PS may take the form of a computer program product stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The communication method supporting CS and PS includes the following steps:

At step 610, at least one network communication device is utilized to build a connection with a PS communication unit of an application device through a network. Wherein, the network communication device may utilize a wired or wireless network communication protocol to build a connection with the network. A PS communication unit of the application device builds a connection with the network through a PS interface.

At step 620, several CS communication devices are utilized to communicate with a CS communication unit of the application device through a CS interface. Wherein, the CS communication devices or the application device can call other devices through HPLMN for communication at step 620.

At step 630, the application device is utilized to convert several voice signals transmitted between the CS communication devices and the at least one network communication device, such that the CS communication devices builds a voice connection with the at least one network communication device. Wherein, the voice signals to be converted at step 630 may include at least one CS signals received from the CS communication devices and at least one PS packet received from the network communication device. Hence, in some embodiments of step 630, the at least one CS signal received from the CS communication devices (such as the signal in an Adaptive Multi-Rate speech codec format) may be converted into at least one signal in a PS format (such as ITU-T G.711 speech codec format) to transmit to the network communication device. In addition, the at least one PS packet received from the network communication device (such as the signal in ITU-T G.711 speech codec format) may be converted into at least one signal in a CS format (such as the signal in an Adaptive Multi-Rate speech codec format) to transmit to the CS communication devices. Therefore, the network communication device, which builds a connection through the network, can participate in a multi-user talk with the CS communication devices.

In some embodiments of step 630, network connection information about the at least one network communication device building the connection with the network may be received. Such network connection information of the at least one network communication device may be an IP address or any other information about the network communication device building the connection with the network. Then, the application device may be utilized to drive the CS communication devices to build the voice connection with the at least one network communication device according to the network connection information.

Furthermore, one of the network communication devices may be assigned to join a multi-use talk. Hence, in another embodiment of step 630, network connection information about each of the network communication devices building the connection with the network may be received. Assigned device information about assigning one of the network communication devices may be received. Then, the application device can be utilized to drive the CS communication devices to build the voice connection with the assigned network communication device according to the network connection information.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A communication system supporting Circuit Switch (CS) and Packet Switching (PS) comprising:
a plurality of CS communication devices;
an application device comprising:
a CS communication unit;
a PS communication unit; and
a processing unit electrically connected to the CS communication unit and the PS communication unit;
at least one network communication device, wherein the at least one network communication device builds a connection with a network;
wherein the at least one network communication device builds a connection with the PS communication unit of the application device through the network, and
wherein, when the CS communication devices communicate with the CS communication unit of the application device through a CS interface, the processing unit of the application device converts a plurality of voice signals transmitted between the CS communication devices and the at least one network communication device, such that the CS communication devices builds a voice connection with the at least one network communication device.

2. The communication system supporting CS and PS of claim 1, wherein the processing unit further comprises:
a network-connection-information receiving module configured to receive network connection information about the at least one network communication device building the connection with the network,
wherein the processing unit drives the CS communication devices to build the voice connection with the at least one network communication device according to the network connection information.

3. The communication system supporting CS and PS of claim 1, wherein number of the at least one network communication device is more than one, and the processing unit further comprises:
a network-connection-information receiving module configured to receive network connection information about each network communication device building the connection with the network,
an assigned-device-information receiving module configured to receive assigned device information about assigning one of the network communication devices,
wherein the processing unit drives the CS communication devices to build the voice connection with the assigned network communication device according to the network connection information.

4. The communication system supporting CS and PS of claim 1, wherein the voice signals comprises at least one CS signals received from the CS communication devices and at least one PS packet received from the at least one network communication device, the application device further comprises:
a codec electrically connected to the processing unit,
wherein the codec converts the at least one CS signal into at least one signal in a PS format for the processing unit to transmit to the at least one network communication device, and
wherein the codec converts the at least one PS packet into at least one signal in a CS format for the processing unit to transmit to the CS communication devices.

5. An application device supporting CS and PS comprising:
a CS communication unit;
a PS communication unit;
a processing unit electrically connected to the CS communication unit and the PS communication unit,
wherein at least one network communication device builds a connection with the PS communication unit of the application device through a network, and
wherein when a plurality of CS communication devices communicate with the CS communication unit of the application device through a CS interface, the processing unit of the application device converts a plurality of voice signals transmitted between the CS communication devices and the at least one network communication device, such that the CS communication devices builds a voice connection with the at least one network communication device.

6. The application device supporting CS and PS of claim 5, wherein the processing unit further comprises:
a network-connection-information receiving module configured to receive network connection information about the at least one network communication device building the connection with the network,
wherein the processing unit drives the CS communication devices to build the voice connection with the at least one network communication device according to the network connection information.

7. The application device supporting CS and PS of claim 5, wherein number of the at least one network communication device is more than one, and the processing unit further comprises:
a network-connection-information receiving module configured to receive network connection information about each network communication device building the connection with the network; and
an assigned-device-information receiving module configured to receive assigned device information about assigning one of the network communication devices,
wherein the processing unit drives the CS communication devices to build the voice connection with the assigned network communication device according to the network connection information.

8. The application device supporting CS and PS of claim 5, wherein the voice signals comprises at least one CS signals received from the CS communication devices and at least one PS packet received from the at least one network communication device, the application device further comprises:
a codec electrically connected to the processing unit,
wherein the codec converts the at least one CS signal into at least one signal in a PS format for the processing unit to transmit to the at least one network communication device, and
wherein the codec converts the at least one PS packet into at least one signal in a CS format for the processing unit to transmit to the CS communication devices.

9. A communication method supporting CS and PS comprising:
(a) utilizing at least one network communication device to build a connection with a PS communication unit of an application device through a network;
(b) utilizing a plurality of CS communication devices to communicate with a CS communication unit of the application device through a CS interface; and
(c) utilizing the application device to convert a plurality of voice signals transmitted between the CS communication devices and the at least one network communication device, such that the CS communication devices builds a voice connection with the at least one network communication device.

10. The communication method supporting CS and PS of claim 9, wherein step (c) comprises:
receive network connection information about the at least one network communication device building the connection with the network; and
utilizing the application device to drive the CS communication devices to build the voice connection with the at least one network communication device according to the network connection information.

11. The communication method supporting CS and PS of claim 9 wherein number of the at least one network communication device is more than one, and step (c) comprises:
receiving network connection information about each network communication device building the connection with the network;
receiving assigned device information about assigning one of the network communication devices; and
utilizing the application device to drive the CS communication devices to build the voice connection with the assigned network communication device according to the network connection information.

12. The communication method supporting CS and PS of claim 9 wherein the voice signals comprises at least one CS signals received from the CS communication devices and at least one PS packet received from the at least one network communication device, and step (c) comprises:
converting the at least one CS signal into at least one signal in a PS format for the processing unit to transmit to the at least one network communication device; and
converting the at least one PS packet into at least one signal in a CS format for the processing unit to transmit to the CS communication devices.
